(19) United States
(12) Patent Application Publication
(10) Pub. No.: US 2008/0164445 A1
(43) Pub. Date: Jul. 10, 2008

(54) Brominated Styrenic Polymer Compositions and Processes For Producing Same

(75) Inventors: Ronny W. Lin, Baton Rouge, LA (US); Charles H. Kolich, Baton Rouge, LA (US); Douglas W. Luther, Baton Rouge, LA (US)

Correspondence Address: ALBEMARLE CORPORATION, 451 FLORIDA STREET, BATON ROUGE, LA, 70801-1765, US

(73) Assignee: ALBEMARLE CORPORATION, Baton Rouge, LA (US)

(21) Appl. No.: 11/971,124

(22) Filed: Jan. 8, 2008

Related U.S. Application Data
(60) Provisional application No. 60/884,337, filed on Jan. 10, 2007.

(51) Int. Cl. C09K 21/14; C08F 14/16

(52) U.S. Cl. 252/601; 526/296

(57) ABSTRACT

This invention provides a multimodal brominated styrenic polymer composition. The composition is comprised of at least one brominated anionic styrenic polymer and at least one brominated non-anionic styrenic polymer. Also provided by this invention are processes for producing multimodal brominated styrenic polymer compositions.

### REFERENCE TO RELATED APPLICATIONS

This Application claims the benefit and priority of U.S. Provisional Application No. 60/884,337, filed Jan. 10, 2007, the disclosure of which is incorporated herein by reference.

### TECHNICAL FIELD

This invention relates to brominated styrenic polymers, their production, and their use as flame retardants.

### BACKGROUND

Brominated styrenic polymers, including brominated anionic styrenic polymers, are known as flame retardants for various polymeric materials such as thermosetting and thermoplastic polymeric materials and resins, e.g., polybutylene terephthalate, polyethylene terephthalate and nylon (a.k.a. polyamides). Improvements in products are almost always welcome, and flame retardants are no exception. Thus, improvements to brominated styrenic polymers are desirable, especially improvements that impart better physical properties while maintaining the flame retardancy of the brominated styrenic polymers.

### SUMMARY OF THE INVENTION

This invention provides multimodal brominated styrenic polymers. These multimodal brominated styrenic polymers have physical properties that can be manipulated as the desired use demands without a diminishment of their flame retardant properties. Without wishing to be bound by theory, it is believed that the multimodality at least contributes to the physical properties of the brominated styrenic polymers of this invention. An advantage provided by present invention is the ability to tailor-make a multimodal brominated styrenic polymer composition of the invention to have desired physical properties by choosing a particular brominated styrenic polymer to constitute each polymer weight fraction, and by varying the relative proportions of the polymer weight fractions.

An embodiment of this invention is a multimodal brominated styrenic polymer composition. The composition is comprised of at least one brominated anionic styrenic polymer and at least one brominated non-anionic styrenic polymer.

Another embodiment of this invention is a process for producing a multimodal brominated styrenic polymer composition. The process comprises mixing together brominated styrenic polymers, wherein the brominated styrenic polymers are at least one brominated anionic styrenic polymer and at least one brominated non-anionic styrenic polymer.

Still another embodiment of this invention comprises an improvement in a process for brominating a styrenic polymer. The improvement comprises that the styrenic polymer being brominated is at least one non-anionic styrenic polymer and at least one anionic styrenic polymer.

Yet another embodiment of the invention is a flame retardant composition which comprises a blend of at least one thermoplastic polymer or at least one thermoset polymer or resin and a flame retardant amount of at least one multimodal brominated styrenic polymer composition of the invention.

These and other embodiments and features of this invention will be still further apparent from the ensuing description and appended claims.

### FURTHER DETAILED DESCRIPTION OF THE INVENTION

The terms “brominated styrenic polymer” and “brominated polystyrene” as used throughout this document refer to a brominated polymer produced by bromination of a pre-existing styrenic polymer such as polystyrene or a copolymer of styrene and at least one other vinyl aromatic monomer, as distinguished from an oligomer or polymer produced by oligomerization or polymerization of one or more brominated styrenic monomers. More specifically, the terms “brominated anionic styrenic polymer” and “brominated anionic polystyrene” as used throughout this document refer to a brominated polymer produced by bromination of a pre-existing anionic styrenic polymer. The term “anionic styrenic polymer” as used throughout this document refers to a styrenic polymer formed using an anionic initiator. Throughout this document, the term “brominated non-anionic styrenic polymer” refers to a brominated polymer produced by bromination of a pre-existing styrenic polymer, where the styrenic polymer was produced by a method other than anionic polymerization. Similarly, the term “non-anionic styrenic polymer” refers to a styrenic polymer produced by a method other than anionic polymerization. Although other methods can produce styrenic polymers, non-anionic styrenic polymers are generally produced via free radical initiation.

As is known in the art, the “modality” of a polymer refers to the form of its molecular weight distribution curve, i.e., the appearance of the graph of the polymer weight fraction as function of the polymer's molecular weight. The molecular weight distribution curve can be viewed as the superposition of the molecular weight distribution curves of the polymer fractions which will accordingly show two or more distinct maxima or at least be distinctly broadened compared with the curves for the individual fractions. A polymer showing such a molecular weight distribution curve is called “bimodal” or “multimodal”, respectively. Bimodal polymers can be considered as a subset of multimodal polymers, and as used herein, bimodal polymers are a subset of multimodal polymers. As used throughout this document, the term “polymer weight fraction” (or “fraction”) refers to the portion of the multimodal polymer that corresponds to one of the maxima on the molecular weight distribution curve.

Polymer molecular weights can be determined by known methods, such as gel permeation chromatography (GPC) analysis of the polymer. For an explanation of determination of molecular weight by GPC, see for example U.S. Pat. No. 6,521,714. As used throughout this document, the term “M_{w}” means weight average molecular weight as determined by GPC with a light scattering detector. A specific procedure for use in determining M_{w} is set forth hereinafter.

A composition of this invention is comprised of at least one brominated anionic styrenic polymer and at least one brominated non-anionic styrenic polymer. Normally and preferably, the brominated styrenic polymer weight fractions have different weight average molecular weights. In the compositions of the invention, at least one polymer weight fraction is a brominated anionic styrenic polymer. Such an anionic brominated polystyrene polymer weight fraction preferably has a M_{w} of about 6000 to about 60,000, more preferably a M_{w} of about 10,000 to about 30,000. A non-anionic brominated polystyrene is at least one polymer weight fraction of the composition. Such a non-anionic brominated polystyrene polymer weight fraction preferably has a M_{w} of about 300,000 to about 800,000.

The proportions of a particular polymer weight fraction in a multimodal composition of the invention can vary widely, from very little, e.g., about 0.5%, to a great majority, e.g., about 99.5%, of the total weight of the composition. For example, for a composition with a modality of about three, the proportions by weight of the fractions can range from about 0.5:0.5:99 to about 0.5:99:0.5 to about 99:0.5:0.5. For a bimodal composition, the proportions of the polymer weight fractions can be about 0.5:99.5 to about 99.5:0.5, but are preferably in the range of about 10:90 to about 90:10. An advantage of having different weight average molecular weights of brominated styrenic polymer constituting each fraction and being able to vary the proportions of the fractions is the ability to tailor-make a brominated styrenic polymer composition of the invention to have desired physical properties. The relative amount of brominated styrenic polymer in each fraction can be increased or decreased as needed to effect a desired change in the properties of the brominated styrenic polymer compositions of the invention.

The brominated styrenic polymers that constitute the polymer weight fractions of the multimodal compositions of this invention can contain any suitable amount of bromine. Typically they contain at least about 50 wt %, preferably at least about 60 wt %, more preferably at least about 67 wt %, and still more preferably in the range of about 68 to about 72 wt % of bromine. Different polymer weight fractions can contain different amounts of bromine, although it is recommended and preferred that higher amounts of bromine are present in most or all fractions, but especially in the polymer weight fraction or fractions that comprise a majority of the multimodal brominated styrenic polymer composition.

One way to produce the multimodal compositions of this invention is to mix together the polymer weight fractions of brominated styrenic polymers. The mixing can be accomplished by any conventional means, for example, melt blending, powder blending, or solution blending. If desired, the brominated styrenic polymers being mixed can be melted together while being mixed together, or they can be solution blended. The relative proportions of the brominated styrenic polymers are chosen so that the resulting composition has the desired properties.

Another way of producing multimodal compositions of this invention is by an improvement to the bromination of styrenic polymers. The improvement comprises that the styrenic polymer being brominated is at least one non-anionic styrenic polymer and at least one anionic styrenic polymer. This process forms multimodal brominated styrenic polymer compositions.

Generally, the anionic styrenic polymers brominated in the processes of this invention have weight average molecular weights of about 2,000 to about 20,000; more preferably, the anionic styrenic polymers have weight average molecular weights of about 3,000 to about 10,000. Typically, the non-anionic styrenic polymers brominated in the processes of this invention have weight average molecular weights of about 100,000 to about 400,000.

For the bromination processes of this invention, the two types of styrenic polymer can be fed to a bromination reaction zone at the same time, or sequentially in any order. When fed at the same time, the feeds need not be initiated or terminated at exactly the same moment in time, nor do the two or more feeds need to occur for the entire time, i.e., interruptions of various duration in one or more feeds can occur without adverse affect upon the bromination process.

Some of the styrenic polymers to be brominated in this invention are made by anionic polymerization procedures. An excellent process for producing anionic polystyrene is described in commonly-owned U.S. Pat. No. 6,657,028. Other methods for producing anionic styrenic polymers are known and reported in the literature. See for example U.S. Pat. Nos. 4,442,273; 4,883,846; 5,717,040; and 5,902,865. A method for producing multimodal anionic styrenic polymers is known; see Anionic Polymerization: Principles and Practical Applications, Henry L. Hsieh and Roderic P. Quirk, New York, 1996 (Marcel Dekker). When the anionic styrenic polymers are made using a lithium initiator, lithium ions remaining with the anionic styrenic polymer at the end of the polymerization process should be removed from the anionic styrenic polymer prior to bromination of the anionic styrenic polymer, as the lithium ions can interfere with the bromination process.

Styrenic polymers which are brominated to form the brominated styrenic polymers of this invention are homopolymers and copolymers of vinyl aromatic monomers. Preferred vinyl aromatic monomers have the formula:

H₂C═CR—Ar

wherein R is a hydrogen atom or an alkyl group having from 1 to 4 carbon atoms and Ar is an aromatic group (including alkyl-ring substituted aromatic groups) of from 6 to 10 carbon atoms. Examples of such monomers are styrene, alpha-methylstyrene, ortho-methylstyrene, meta-methylstyrene, para-methylstyrene, para-ethylstyrene, isopropenyltoluene, vinylnaphthalene, isopropenylnaphthalene, vinylbiphenyl, vinylanthracene, the dimethylstyrenes, tert-butylstyrene, the several bromostyrenes (such as the monobromo-, dibromo-, and tribromo- variants). Polystyrene is the preferred reactant. When the brominated styrenic polymer is made by bromination of a copolymer of two or more vinyl aromatic monomers, it is preferred that styrene be one of the monomers and that styrene comprise at least 50 weight percent of the copolymerizable vinyl aromatic monomers. If a bromo styrenic polymer is selected for bromination to make a brominated styrenic polymer, the initial bromostyrenic polymer must have a lower bromine content than the bromine content to be present in the brominated styrenic polymer of this invention. Polystyrene itself is preferred as the anionic styrenic polymer to be brominated. Use can be made however of other styrenic polymers such as those made from at least 50 weight percent, and more desirably at least 80 weight percent, of styrene and/or alpha-methylstyrene with the balance being derived from ring substituted styrenic monomers. Thus, the “styrenic polymers” used in the practice of this invention are polymers of one or more styrenic monomers in which at least 50%, preferably at least 80%, and more preferably essentially 100% of the aromatic groups in the polymer have a hydrogen atom on at least one ortho position, and when the ring system of such aromatic groups is composed of a combination of phenyl groups and alkyl-substituted phenyl groups, at least 50%, preferably at least 80%, and more preferably essentially 100% of all such phenyl groups have a hydrogen atom on each ortho position.

Processes for the bromination of styrenic polymers are disclosed in U.S. Pat. Nos. 5,677,390; 5,686,538; 5,767,203; 5,852,131; 5,852,132; 5,916,978; 6,133,381; 6,207,765; 6,232,393; 6,232,408; 6,235,831; 6,235,844; 6,326,439; and 6,521,714 which disclosures are incorporated herein by reference.

The multimodal brominated styrenic polymer compositions of this invention may be used as flame retardants in formulations with virtually any flammable material. The material may be macromolecular, for example, a cellulosic material or a polymer. Illustrative polymers are: olefin polymers, cross-linked and otherwise, for example homopolymers of ethylene, propylene, and butylene; copolymers of two or more of such alkene monomers and copolymers of one or more of such alkene monomers and other copolymerizable monomers, for example, ethylene/propylene copolymers, ethylene/ethyl acrylate copolymers and ethylene/propylene copolymers, ethylene/acrylate copolymers and ethylene/vinyl acetate copolymers; polymers of olefinically unsaturated monomers, for example, styrene copolymers, polyurethanes; polyamides; polyimides; polycarbonates; polyethers; acrylic resins; polyvinyl chloride; thermoset polymers or resins, for example, epoxy resins; elastomers, for example, butadiene/styrene copolymers and butadiene/acrylonitrile copolymers; terpolymers of acrylonitrile, butadiene and styrene; natural rubber; butyl rubber and polysiloxanes. The polymer may be, where appropriate, cross-linked by chemical means or by irradiation. The multimodal brominated styrenic polymer compositions of this invention can be used in textile applications, such as in latex-based back coatings.

Preferably the multimodal brominated styrenic polymer compositions of this invention are used as additive flame retardants for various thermoplastic polymers. Thus among the embodiments of this invention are flame retardant compositions comprising at least one thermoplastic polymer and a flame retardant quantity of at least one multimodal brominated styrenic polymer composition of this invention.

Particular thermoplastics with which the multimodal brominated styrenic polymer compositions of this invention can be blended pursuant to further embodiments of this invention include polyesters such as polyethylene terephthalate, polybutylene terephthalate, polycyclohexylene dimethylene terephthalate, polytrimethylene terephthalate, blends or mixtures of two or more of these, and analogous copolymeric thermoplastic polyesters, especially when filled or reinforced with a reinforcing filler such as glass fiber. Preferred thermoplastic polyesters are polyethylene terephthalate and polybutylene terephthalate. Polyamide thermoplastics, such as polyamide 6, polyamide 6,6, polyamide 12, etc., again preferably when glass filled, can also be effectively flame retarded in like manner. Other thermoplastic polymers that can be effectively flame retarded by addition of a brominated styrenic polymer composition of this invention include but are not limited to styrenic polymers, high impact polystyrenes, crystal polystyrenes, polyolefins, ABS, MABS, SAN, aromatic polycarbonates, polyphenylene ethers, and polymer blends such as aromatic polycarbonate-ABS blends, polyphenylene ether-polystyrene blends, and similar substances. One group of thermoplastic polymers which can be effectively flame retarded by use of at least one brominated anionic styrenic polymer composition of this invention is (1) a thermoplastic styrenic polymer, (2) a thermoplastic acrylonitrile-butadiene-styrene polymer, (3) a thermoplastic polyester, or (4) a thermoplastic polyamide. Conventional additives, such as flame retardant synergists, antioxidants, UV stabilizers, pigments, impact modifiers, fillers, acid scavengers, blowing agents, and the like, can be included with the formulations as is appropriate. Preferred polymer blends of this invention do contain a flame retardant synergist or glass fiber filler or reinforcement, and most preferably both a synergist and a reinforcing fiber and/or filler.

The multimodal brominated styrenic polymer compositions of this invention, which are flame retardants, are used in flame retardant amounts, which typically are within the range of from about 5 to about 25 wt %, the wt % being based on the total weight of the thermoplastic polymer formulation or blend. When used, the amount of reinforcing fillers such as glass fiber will typically be in the range of up to about 50 wt % based on the total weight of the finished composition. The amount of flame retardant synergist, when used, such as antimony trioxide, antimony pentoxide, sodium antimonate, potassium antimonate, iron oxide, zinc borate, or analogous synergist generally will be in the range of up to about 12 wt % based on the total weight of the finished composition. Departures from the foregoing ranges of proportions are permissible whenever deemed necessary or desirable under the particular circumstances at hand, and such departures are within the scope and contemplation of this invention.

Masterbatch compositions wherein the components except for the substrate thermoplastic polymer are in suitable relative proportions but are blended in a smaller amount of the substrate polymer, are also within the scope of this invention. Thus this invention includes compositions which comprise at least one thermoplastic polymer such as a polyalkylene terephthalate or a nylon polymer or a high impact polystyrene with which has been blended a multimodal brominated styrenic polymer composition (preferably a multimodal brominated polystyrene composition) of this invention in a weight ratio (substrate polymer: multimodal brominated polystyrene composition) in the range of, say, 1:99 to 70:30. Such masterbatch blends need not, but may also contain filler or reinforcing fiber and/or at least one flame retardant synergist such as iron oxide, zinc borate, or preferably an antimony oxide synergist such as antimony trioxide, antimony pentoxide, sodium antimonate, or potassium antimonate. Typical examples of reinforcing agents or fillers that can be used include low-alkali E-glass, carbon fibers, potassium titanate fibers, glass spheres or microballoons, whiskers, talc, wollastonite, kaolin, chalk, calcined kaolin, and similar substances. Sizing agents can be used with such reinforcing agents or fillers, if desired. A number of suitable glass-filled polyalkylene terephthalates or nylon molding compositions are available on the open market, and these can be used in preparing the masterbatch compositions of this invention.

Also provided by this invention are additive blends composed of a multimodal brominated styrenic polymer composition of this invention and a synergist such as, for example, a blend of 75 parts by weight of a brominated polystyrene composition and 25 parts by weight of a synergist such as antimony trioxide, antimony pentoxide, sodium antimonate, potassium antimonate, iron oxide, zinc borate, or analogous synergist. Typically such blends will contain in the range of about 70 to about 98 parts by weight of the brominated polystyrene composition and about 30 to about 2 parts by weight of the synergist, with the total of the two components being 100 parts by weight. Suitable amounts of other suitable additive components can also be included in such additive blends.

Various known procedures can be used to prepare the blends or formulations constituting such additional compositions of this invention. For example the polyalkylene terephthalate polymer or a nylon polymer and the multimodal brominated styrenic polymer composition, such as a multimodal brominated polystyrene composition, and any other components or ingredients to be incorporated into the finished blend can be blended together in powder form and thereafter molded by extrusion, compression, or injection molding. Likewise the components can be mixed together in a Banbury mixer, a Brabender mixer, a roll mill, a kneader, or other similar mixing device, and then formed into the desired form or configuration such as by extrusion followed by comminution into granules or pellets, or by other known methods.

Properties of, and Analytical Methods for, Brominated Styrenic Polymers

The following properties can be determined for the multimodal brominated styrenic polymer compositions of the invention.

GPC Weight Average Molecular Weights and Polydispersity. A preferred procedure used for determining GPC weight average molecular weights is described here. The M_{w} values are obtained by GPC using a Waters model 510 HPLC pump and, as detectors, a Waters Refractive Index Detector, Model 410 and a Precision Detector Light Scattering Detector, Model PD2000. The columns are Waters, μStyragel, 500 Å, 10,000 Å and 100,000 Å. The autosampler is a Shimadzu, Model Sil 9A. A polystyrene standard (M_{w}=185,000) is routinely used to verify the accuracy of the light scattering data. The solvent used is tetrahydrofuran, HPLC grade. The test procedure used entails dissolving 0.015-0.020 g of sample in 10 mL of THF. An aliquot of this solution is filtered and 50 μL is injected on the columns. The separation is analyzed using software provided by Precision Detectors for the PD 2000 Light Scattering Detector. The instrument provides results in terms of weight average molecular weight and also in terms of number average molecular weight. Thus, to obtain a value for polydispersity, the value for weight average molecular weight is divided by the value for number average molecular weight.

Melt Flow Index Test. To determine the melt flow index of the brominated styrenic polymers of this invention, the procedure and test equipment of ASTM Test Method D1238-99 are used. The extrusion plastometer is operated at 270□C and 2.16 kg applied pressure. The samples used in the tests are composed of 50 parts by weight of antimony oxide, a calculated quantity in the range of about 200 to about 250 parts by weight of the brominated styrenic polymer that will provide a final blend containing 15.0 wt % Br based on the Br content of the brominated styrenic polymer, and sufficient glass-filled nylon 6,6 (Zytel polymer, from DuPont) to give a total of 1000 parts by weight.

Total Bromine Content. Since brominated styrenic polymers have good, or at least satisfactory, solubility in solvents such as tetrahydrofuran (THF), the determination of the total bromine content for the brominated styrenic polymers is easily accomplished by using conventional X-Ray Fluorescence techniques. The sample analyzed is a dilute sample, say 0.1±0.05 g brominated polystyrene in 60 mL THF. The XRF spectrometer can be a Phillips PW1480 Spectrometer. A standardized solution of bromobenzene in THF is used as the calibration standard. The total bromine values described herein and reported in the Examples are all based on the XRF analytical method.

Thermal Stability Test. The brominated styrenic polymers such as brominated polystyrenes have exceptional stability in the Thermal Stability test. This means that in preferred brominated styrenic polymers of this invention, the amount of HBr released under the stringent test conditions is very small, 200 ppm or less, and in many cases less than 100 ppm. This in turn minimizes, if not eliminates, corrosion of thermoplastic polymer processing equipment when processing a thermoplastic polymer containing a flame retardant quantity of a preferred brominated styrenic polymer of this invention at elevated polymer processing temperatures. To determine thermal stability and estimate the corrosive potential of a sample, the Thermal Stability Test is used. The test procedure, described in U.S. Pat. No. 5,637,650, is used in the following manner. Each sample is run in duplicate. A 2.00±0.01 g sample is placed into a new clean 20×150 mm test tube. With a neoprene stopper and Viton® fluoroelastomer tubing, the test tube is connected to a nitrogen purge line with exit gas from the test tube being passed successively through subsurface gas dispersion frits in three 250-mL sidearm filter flasks each containing 200 mL of 0.1 N NaOH and 5 drops of phenolphthalein. The temperature at which the Thermal Stability Test is conducted will vary with the intended use of the brominated styrenic polymer composition. With a constant nitrogen purge at 0.5 SCFH, the test tube is heated at the desired temperature in a molten salt bath (51.3% KNO₃/48.7% NaNO₃) for 15 minutes followed by 5 minutes at ambient temperature. The test tube containing the sample is then replaced with a clean dry test tube, and the apparatus is purged with nitrogen for an additional 10 minutes with the empty test tube in the salt bath (at the desired temperature). The test tube, tubing and gas dispersion tubes are all rinsed with deionized water, and the rinse is combined quantitatively with the solutions in the three collection flasks. The combined solution is acidified with 1:1 HNO₃ and titrated with 0.01 N AgNO₃ using an automatic potentiometric titrator (Metrohm 670, 716, 736, or equivalent). Results are calculated as ppm HBr, ppm HCl, and ppm HBr equivalents as follows:

ppm HBr=(EP 1)(N)(80912)/(sample wt.)

ppm HCl=(EP 2−EP 1)(N)(36461)/(sample wt.)

ppm HBr equivalents=(EP 2)(N)(80912)/(sample wt.)

where EP(x)=mL of AgNO₃ used to reach end point x; and N=normality of AgNO₃. The tubing is thoroughly dried with nitrogen before the next analysis. Each day before the first sample, three empty clean test tubes are run as blanks to assure there is no residual hydrogen halide in the system.

Thermogravimetric Analysis. Thermogravimetric analysis (TGA) is also used to test the thermal behavior of the brominated styrenic polymers of this invention. The TGA values are obtained by use of a TA Instruments Thermogravimetric Analyzer. Each sample is heated on a Pt pan from 25° C. to about 600° C. at 10° C./min with a nitrogen flow of 50-60 mL/min.

DSC Values. DSC values are obtained with a TA Instruments DSC Model 2920. Samples are heated from 25° C. to 400° C. at 10° C./min under nitrogen.

ΔE Color Value. To determine the color attributes of the brominated polymers of this invention, use is again made of the ability to dissolve brominated styrenic polymers in easy-to-obtain solvents, such as chlorobenzene. The analytical method used is quite straight-forward. Weigh 5 g±0.1 g of the brominated polystyrene into a 50 mL centrifuge tube. To the tube also add 45 g±0.1 g chlorobenzene. Close the tube and shake for 1 hour on a wrist action shaker. After the 1 hour shaking period, examine the solution for undissolved solids. If a haze is present, centrifuge the solution for 10 minutes at 4000 rpm. If the solution is still not clear, centrifuge an additional 10 minutes. Should the solution remain hazy, then it should be discarded as being incapable of accurate measurement. If, however, and this is the case most of the time, a clear solution is obtained, it is submitted for testing in a HunterLab ColorQuest Sphere Spectrocolorimeter. A transmission cell having a 20-mm transmission length is used. The colorimeter is set to “Delta E-lab” to report color as ΔE and to give color values for “L”, “a” and “b”. Product color is determined as total color difference ΔE using Hunter L, a, and b scales for the 10% by weight concentrations of the product in chlorobenzene versus chlorobenzene according to the formula:

ΔE=[(ΔL)²+(Δa)²+(Δb)²]^{1/2}

Ionic Bromine Content. To determine the ionic bromine content of brominated styrenic polymers, the procedure used involves dissolving a sample of the polymer in a suitable organic solvent medium and titrating the solution with a standard solution of silver nitrate. In particular, a 2.0 gram sample of the brominated styrenic polymer weighed to the nearest 0.1 mg is placed in a 600 mL beaker, followed by 200 mL of tetrahydrofuran (THF), and a stir bar. The solids are stirred until completely dissolved. To this solution is added 50 mL of toluene, and the mixture is stirred. Immediately prior to conducting the titration, 50 mL of acetone, then 50 mL of isopropyl alcohol, and then 10 mL of glacial acetic acid are added to the sample mixture. The sample is then titrated immediately with standardized 0.01N AgNO₃ using an automatic potentiometric titrator such as a Metrohm 670, 716, or 736, or equivalent. Reagent grade (A.C.S.) THF, toluene, acetone, isopropyl alcohol, and acetic acid are used in the procedure. The analysis is conducted using duplicate samples, plus a determination on a blank sample conducted in identical fashion except using no polymer. If both ionic bromine and ionic chlorine are present, the bromide titrates first. The distance between the inflection points is the chloride titre. The average of the two sample determinations is reported. However, if duplicate samples do not agree within less than 10% of each other, an additional replicate sample is analyzed in the same way, and the average of the three analyses is reported to three significant digits. The calculation for ionic bromine or chlorine are as follows:

$$Ionic bromine ( ppm ) = \frac{\begin{matrix}mL {AgNO}_{3} \times normality of {AgNO}_{3} \times \\ ( 7.99 ) \times {10}^{4}\end{matrix}}{sample weight in grams}$$

$$Ionic chlorine ( ppm ) = \frac{\begin{matrix}mL {AgNO}_{3} \times normality of {AgNO}_{3} \times \\ ( 3.545 ) \times {10}^{4}\end{matrix}}{sample weight in grams}$$

$$mL {AgNO}_{3} = mL required for sample - mL required for blank$$

The brominated styrenic polymer compositions of the invention contain less than about 6000 ppm of aliphatic bromide. Such compositions may contain some chlorine atoms, but the amount will be insignificant, usually less than about 500 ppm, and where possible, less than about 100 ppm. Preferred brominated polystyrene polymers are those in which the chlorine content is less than 500 ppm in accordance with X-Ray Fluorescence analysis. It is beneficial, from the viewpoint of economy and performance, that the aliphatic bromide content be less than about 4000 ppm, say within the range of about 1000 ppm to about 3000 ppm. Most beneficial are those aliphatic bromide contents which are less than about 1500 ppm.

Thus, in accordance with this invention, the multimodal brominated styrenic polymers preferably have one or more of the following properties:
(i) a thermal stability in the Thermal Stability Test of 200 ppm HBr or less, preferably 150 ppm of HBr or less, and more preferably 100 ppm of HBr or less;
(ii) a TGA temperature for 1% weight loss which is 340° C. or higher, preferably within the range of from about 340° C. to about 380° C., and more preferably within the range of from about 345° C. to about 380° C.;
(iii) a ΔE color value, measured using 10 wt % solutions in chlorobenzene, of less than about 25, preferably less than about 20, and more preferably less than about 12;
(iv) an ionic bromine content of 2000 ppm or less, preferably 1500 ppm or less, more preferably 1000 ppm or less, and still more preferably 500 ppm or less;
(v) an aliphatic bromide content of less than about 6000 ppm, preferably less than about 4000 ppm, more preferably within the range of from about 1000 ppm to about 3000 ppm, still more preferably less than about 1500 ppm; and
(vi) a chlorine content, if any, of less than about 700 ppm Cl, and more preferably, less than about 500 ppm Cl, and still more preferably less than about 100 ppm Cl.

The following examples are presented for purposes of illustration, and are not intended to impose limitations on the scope of this invention.

### EXAMPLE 1

Brominated anionic polystyrene (5.0 g, M_{w}=3500) is transferred to a flask. Brominated polystyrene (5.0 g, M_{w}=630,000) is added to the flask. The two brominated polystyrenes are dry blended, forming a composition of bimodal brominated polystyrene.

It is to be understood that the reactants and components referred to by chemical name or formula anywhere in this document, whether referred to in the singular or plural, are identified as they exist prior to coming into contact with another substance referred to by chemical name or chemical type (e.g., another reactant, a solvent, or etc.). It matters not what preliminary chemical changes, transformations and/or reactions, if any, take place in the resulting mixture or solution or reaction medium as such changes, transformations and/or reactions are the natural result of bringing the specified reactants and/or components together under the conditions called for pursuant to this disclosure. Thus the reactants and components are identified as ingredients to be brought together in connection with performing a desired chemical operation or reaction or in forming a mixture to be used in conducting a desired operation or reaction. Also, even though an embodiment may refer to substances, components and/or ingredients in the present tense (“is comprised of”, “comprises”, “is”, etc.), the reference is to the substance, component or ingredient as it existed at the time just before it was first contacted, blended or mixed with one or more other substances, components and/or ingredients in accordance with the present disclosure.

Also, even though the claims may refer to substances in the present tense (e.g., “comprises”, “is”, etc.), the reference is to the substance as it exists at the time just before it is first contacted, blended or mixed with one or more other substances in accordance with the present disclosure.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Each and every patent or other publication or published document referred to in any portion of this specification is incorporated in toto into this disclosure by reference, as if fully set forth herein.

This invention is susceptible to considerable variation within the spirit and scope of the appended claims.

1. A multimodal brominated anionic styrenic polymer composition which is comprised of at least one brominated anionic styrenic polymer and at least one brominated non-anionic styrenic polymer

2. A composition as in claim 1 wherein said brominated anionic styrenic polymer has a M_{w} of about 6000 to about 60,000.

3. A composition as in claim 1 wherein said brominated anionic styrenic polymer has a M_{w} of about 10,000 to about 30,000.

4. A composition as in claim 1 wherein
the brominated anionic styrenic polymer contains at least about 50 wt % of bromine, and/or
the brominated non-anionic styrenic polymer contains at least about 50 wt % of bromine.

5. A composition as in claim 1 wherein said brominated anionic styrenic polymer has a M_{w} of about 10,000 to about 30,000, and wherein the brominated anionic styrenic polymer contains at least about 50 wt % of bromine.

6. A process for producing a multimodal brominated styrenic polymer composition, which process comprises mixing together brominated styrenic polymers, wherein said brominated styrenic polymers are at least one brominated anionic styrenic polymer and at least one brominated non-anionic styrenic polymer.

7. A process as in claim 6 wherein the brominated anionic styrenic polymers are melted together while being mixed together.

8. A process as in claim 6 wherein one brominated anionic styrenic polymer weight fraction has a M_{w} of about 6,000 to about 60,000.

9. A process as in claim 6 wherein one brominated anionic styrenic polymer weight fraction has a M_{w} of about 10,000 to about 30,000.

10. A process as in claim 6 wherein
the brominated anionic styrenic polymer contains at least about 50 wt % of bromine, and/or
the brominated non-anionic styrenic polymer contains at least about 50 wt % of bromine.

11. A process as in claim 6 wherein the brominated anionic styrenic polymers are melted together while being mixed together, wherein one brominated anionic styrenic polymer weight fraction has a M_{w} of about 6,000 to about 60,000, and wherein the brominated anionic styrenic polymer contains at least about 50 wt % of bromine.

12. A process as in claim 11 wherein the brominated non-anionic styrenic polymer contains at least about 50 wt % of bromine.

13. In a process for brominating a styrenic polymer, the improvement which comprises that the styrenic polymer being brominated is at least one non-anionic styrenic polymer and at least one anionic styrenic polymer.

14. A process as in claim 13 wherein the brominated anionic styrenic polymer has a M_{w} of about 6,000 to about 60,000.

15. A process as in claim 13 wherein one brominated anionic styrenic polymer weight fraction has a M_{w} of about 10,000 to about 30,000.

16. A flame retardant composition which comprises a blend of at least one thermoplastic polymer or at least one thermoset polymer or resin and a flame retardant amount of at least one multimodal brominated anionic styrenic polymer composition which is comprised of at least one brominated anionic styrenic polymer and at least one brominated non-anionic styrenic polymer.

17. A composition as in claim 16 wherein said brominated anionic styrenic polymer has a M_{w} of about 6000 to about 60,000.

18. A composition as in claim 16 wherein said brominated anionic styrenic polymer has a M_{w} of about 10,000 to about 30,000 and wherein the brominated anionic styrenic polymer contains at least about 50 wt % of bromine.

19. A composition as in claim 16 wherein
the brominated anionic styrenic polymer contains at least about 50 wt % of bromine, and/or
the brominated non-anionic styrenic polymer contains at least about 50 wt % of bromine.
